(19) United States
(12) Patent Application Publication
(10) Pub. No.: US 2024/0095516 A1
(43) Pub. Date: Mar. 21, 2024

(54) NEURAL NETWORK TRAINING USING EXCHANGE DATA

(71) Applicant: INTERNATIONAL BUSINESS MACHINES CORPORATION, Armonk, NY (US)

(72) Inventors: Raghuveer Prasad Nagar, Kota (IN); Prashant Pillai, Bangalore (IN); Suvojyoti Sinha Ray, Hooghly (IN); Pradeep Kumar Katherapally, Yemmiganur (IN)

(21) Appl. No.: 17/948,129

(22) Filed: Sep. 19, 2022

(51) Int. Cl. G06N 3/08; G06N 3/04

(52) U.S. Cl. CPC G06N 3/08; G06N 3/0481

(57) ABSTRACT

A computer-implemented process for training a neural network includes the following operations. Return data received from a return channel is evaluated against a threshold. Based upon the threshold being satisfied, the return data is validated, and the return data is cognitive processed to generate a return insight. Using the neural network and based upon the return insight, a corrective action is generated. The neural network is trained using feedback generated based upon the corrective action. The threshold is then updated using the neural network.

### BACKGROUND

The present invention relates to neural network training, and more specifically, to using exchange data to train a neural network for improved threshold and action item determination.

Neural networks, also known as artificial neural networks (ANNs) or simulated neural networks (SNNs), are a subset of machine learning and are at the heart of deep learning algorithms. Neural networks are comprised of node layers, which contain an input layer, one or more hidden layers, and an output layer. Each node, or artificial neuron, within a layer connects to another and has an associated weight and threshold. If the output of any individual node is above the specified threshold value, that node is activated, sending data to the next layer of the neural network. Neural networks rely on training data to learn and improve their accuracy over time. Once these learning algorithms are fine-tuned for accuracy, they are powerful tools in computer science and artificial intelligence and allow data to be classified and clustered at a high velocity.

Because of their flexibility and power, neural networks have been used for many different types of applications. Neural networks, for example, have been used in commercial settings, such as in the prediction of retail sales. However, the use of neural networks in the opposite of a sale (i.e., a return) is limited. When a customer (i.e., user) returns a product, that user may request a new (or different) product in exchange for the originally-purchased product. Oftentimes, an exchanged may be initiated by a user for reasons including: (i) wrong item, (ii) item not as described, (iii) item not working, and (iv) found a better item. While the ‘found a better item’ may be one a very common reason for an exchange, sellers/retailers and manufacturers do not leverage this information. Consequently, what is needed is an improved neural network that could timely and correctly suggest corrective actions when an exchange is being requested based upon ‘found a better item’ being the stated reason for the exchange.

### SUMMARY

A computer-implemented process for training a neural network includes the following operations for training a neural network. Return data received from a return channel is evaluated against a threshold. Based upon the threshold being satisfied, the return data is validated, and the return data is cognitively processed to generate a return insight. Using the neural network and based upon the return insight, a corrective action is generated. The neural network is trained using feedback generated based upon the corrective action. The threshold is then updated using the neural network.

In other aspects of the process, the return data can include attribute data of an originally-obtained product and feature data of a new product, and the cognitive processing includes comparing the attribute data on the originally-obtained product with the attribute data of the new product. The validating the return data includes supplementing the return data with additional attribute data. The corrective action is generated by generating an electronic message that identifies the corrective action and electronically communicating the electronic message to the manufacturer. The feedback is generated based upon monitoring the manufacturer for implementation of the corrective action. The corrective action is generated by generating an electronic message that identifies the corrective action and electronically communicating the electronic message to the supplier. The corrective action includes readjusting an electronic display of a product attribute of an originally-obtained product.

A computer hardware system for training a neural network includes a hardware processor configured to perform the following executable operations. Return data received from a return channel is evaluated against a threshold. Based upon the threshold being satisfied, the return data is validated, and the return data is cognitively processed to generate a return insight. Using the neural network and based upon the return insight, a corrective action is generated. The neural network is trained using feedback generated based upon the corrective action. The threshold is then updated using the neural network.

In other aspects of the hardware system, the return data can include attribute data of an originally-obtained product and feature data of a new product, and the cognitive processing includes comparing the attribute data on the originally-obtained product with the attribute data of the new product. The validating the return data includes supplementing the return data with additional attribute data. The corrective action is generated by generating an electronic message that identifies the corrective action and electronically communicating the electronic message to the manufacturer. The feedback is generated based upon monitoring the manufacturer for implementation of the corrective action. The corrective action is generated by generating an electronic message that identifies the corrective action and electronically communicating the electronic message to the supplier. The corrective action includes readjusting an electronic display of a product attribute of an originally-obtained product.

A computer program product includes a computer readable storage medium having stored therein program code for training a neural network. The program code, which when executed by a computer hardware system, cause the computer hardware system to perform the following. Return data received from a return channel is evaluated against a threshold. Based upon the threshold being satisfied, the return data is validated, and the return data is cognitively processed to generate a return insight. Using the neural network and based upon the return insight, a corrective action is generated. The neural network is trained using feedback generated based upon the corrective action. The threshold is then updated using the neural network.

In other aspects of the computer program product, the return data can include attribute data of an originally-obtained product and feature data of a new product, and the cognitive processing includes comparing the attribute data on the originally-obtained product with the attribute data of the new product. The validating the return data includes supplementing the return data with additional attribute data. The corrective action is generated by generating an electronic message that identifies the corrective action and electronically communicating the electronic message to the manufacturer. The feedback is generated based upon monitoring the manufacturer for implementation of the corrective action. The corrective action is generated by generating an electronic message that identifies the corrective action and electronically communicating the electronic message to the supplier. The corrective action includes readjusting an electronic display of a product attribute of an originally-obtained product.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a flowchart of a typical reinforced learning (RL) approach.

FIGS. 2A and 2B are block diagrams respectively schematically illustrating a reinforced learning (RL) approach and a deep Q-learning approach (DQN).

FIG. 3 is a block diagram illustrating an architecture for implementing a neural network-based, return action-implementation system according to an embodiment of the present invention.

FIG. 4 is a flowchart implemented the system of FIG. 3 according to an embodiment of the present invention.

FIG. 5 is a block diagram illustrating an example of computer environment for implementing the architecture and methodology of FIGS. 3 and 4.

### DETAILED DESCRIPTION

The present disclosure is directed to training a neural network. Return data received from a return channel is evaluated against a threshold. Based upon the threshold being satisfied, the return data is validated, and the return data is cognitive processed to generate a return insight. Using the neural network and based upon the return insight, a corrective action is generated. The neural network is trained using feedback generated based upon the corrective action. The threshold is then updated using the neural network.

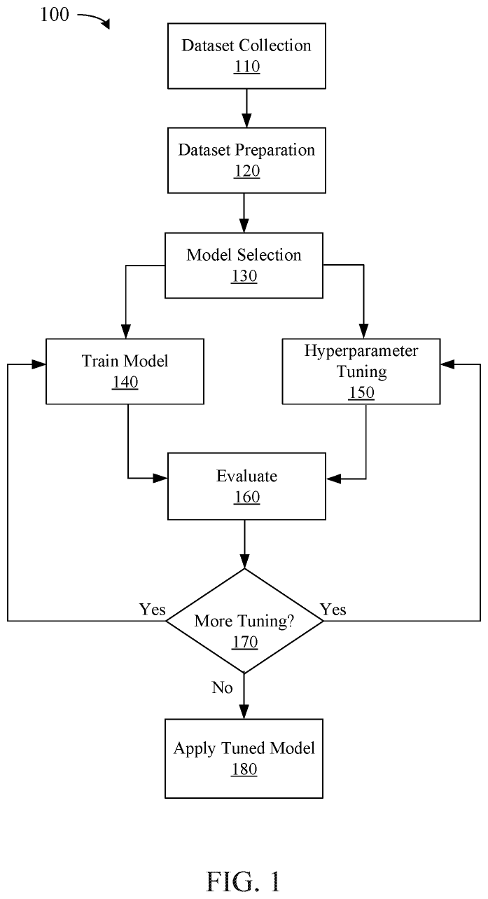

With reference to FIG. 1, a generic process 100 for machine learning is disclosed. In 110, the data used for the dataset is collected. As conventionally known, the quality of the machine learning model (e.g., a neural network) being trained is dependent upon the quantity and quality of the data in the dataset. In 120, the data in the dataset is prepared, and this may involve a wide variety of different operations. For example, if the data comes from different sources, the data may require normalization and data type conversions. Also, duplicate data may be removed and errors/omissions in the data may be corrected. The data can also be randomized to reduce the impact of the particular order in which the data is collected and/or prepared.

The dataset can also be split up into multiple portions. One portion of the dataset (referred to herein as the training dataset), typically the largest portion, is used to train the model (e.g., tune the parameters of the model). Another portion of the dataset (referred to herein as the test dataset) is used to validate the final trained model. Still another portion of the dataset (referred to herein as the validation dataset) is used to tune hyperparameters. In other instances, k-fold cross-validation can be used in place of a test and/or validation dataset—particularly in situations in which the amount of data is limited.

In 130, the model to be trained is selected. There are a number of known models that can be used with machine learning. A non-exclusive list of these models includes linear regression, Deep Neural Networks (DNN), logistic regression, decision trees, Linear Discriminant Analysis (LDA), Support Vector Machines (SVM), and K-nearest Neighbors (kNN). Depending upon the type of solution needed for a particular application, one or more models may be better suited. For example, a DNN is known to provide good results for image recognition. As another example, models typically used for NLP include Bidirectional Encoder Representations from Transformers (BERT) and Generative Pre-trained Transformer (GPT).

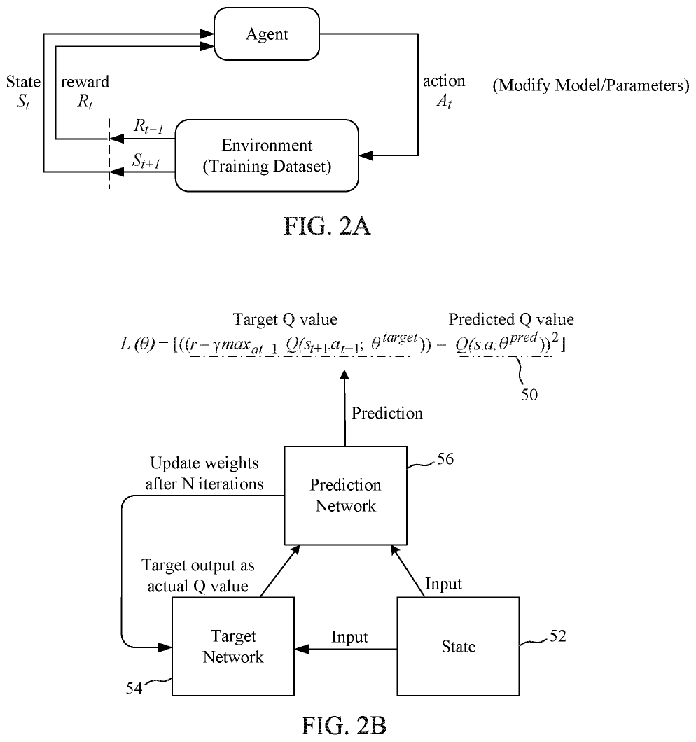

In 140, the parameters of the model are tuned. There are many different types of known techniques used to train a model. Some of these techniques are discussed in further detail regarding FIGS. 2A-2B. In 150, hyperparameters can be tuned. Hyperparameters are variables that govern the training process itself and differ from input data (i.e., the training data) and the parameters of the model. Examples of hyperparameters include, for example, the number of hidden layers in a DNN between the input layer and the output layer. Other examples include number of training steps, learning rate, and initialization values. In certain instances, the validation dataset can be used as part of this tuning process. Although illustrated as being separate from the tuning of the parameters of model in 150, the tuning of the hyperparameters can be performed in parallel with or incorporated with the tuning of the parameters of the model in 140.

In 160, the parameters of the model and the hyperparameters are evaluated. This typically involves using some metric or combination of metrics to generate an objective descriptor of the performance of the model. The evaluation typically uses data that has yet to be seen by the model (e.g., the test dataset). The operations of 140-160 continue until a determination, in 170, that no additional tuning is to be performed. In 180, the tuned model is applied to real-world data.

Machine learning paradigms include supervised learning (SL), unsupervised learning (UL), and reinforced learning (RL). RL differs from SL by not requiring labeled input/output pairs and not requiring sub-optimal actions to be explicitly corrected. FIG. 2A schematically illustrates a generic RL approach. In describing RL, the following terms are oftentimes used. The “environment” refers to the world in which the agent operations. The “State” (Sₜ) refers to a current situation of the agent. Each State (Sₜ) may have one or more dimensions that describe the State. The “reward” (Rₜ) is feedback from the environment (also illustrated as “r” in FIG. 2B), which is used to evaluate actions (Aₜ) taken by the agent. In other words, a reward function, which is part of the environment, generates the reward (Rₜ), and the reward function reflects the desired goal of the model being trained. The “policy” is a methodology by which to map the State (Sₜ) of the agent to certain actions (Aₜ). The “value” is a future reward received by an agent by taking an action (Aₜ) in a particular State (Sₜ). Ultimately, the goal of the agent is to generate actions (Aₜ) that maximize the reward function.

Examples of RL algorithms that may be used include Markov decision process (MDP) (i.e., the methodology illustrated in FIG. 2A), Monte Carlo methods, temporal difference learning, Q-learning, Deep Q Networks (DQN), State-Action-Reward-State-Action (SARSA), a distributed cluster-based multi-agent bidding solution (DCMAB), and the like. FIG. 2B illustrates one example of the operation of a DQN model. DQN is a combination of deep learning (i.e., neural network based) and reinforced learning. Deep learning is another subfield of machine learning that involves artificial neural networks. An example of a computer system that employs deep learning is IBM's Watson. While the terms “neural network” and “deep learning” are oftentimes used interchangeably, by popular convention, deep learning (e.g., with a DNN), refers to a neural network with more than three layers inclusive of the inputs and the output. A neural network with just two or three layers is considered just a basic neural network.

A neural network can be seen as a universal functional approximator that can be used to replace the Q-table used in Q-learning. In a DQN model, the loss function 50 is represented as a squared error of the target Q value and prediction Q value. Error is minimized by optimizing the weights, θ. In DQN, two separate networks (i.e., target network 54 and prediction network 56 having the same architecture) can be respectively employed to estimate target and prediction Q values based upon state 52. The result from the target model is treated as a ground truth for the prediction network 56. The weights for the prediction network 56 get updated every iteration and the weights of the target network 54 get updated with the prediction network 56 after N iterations.

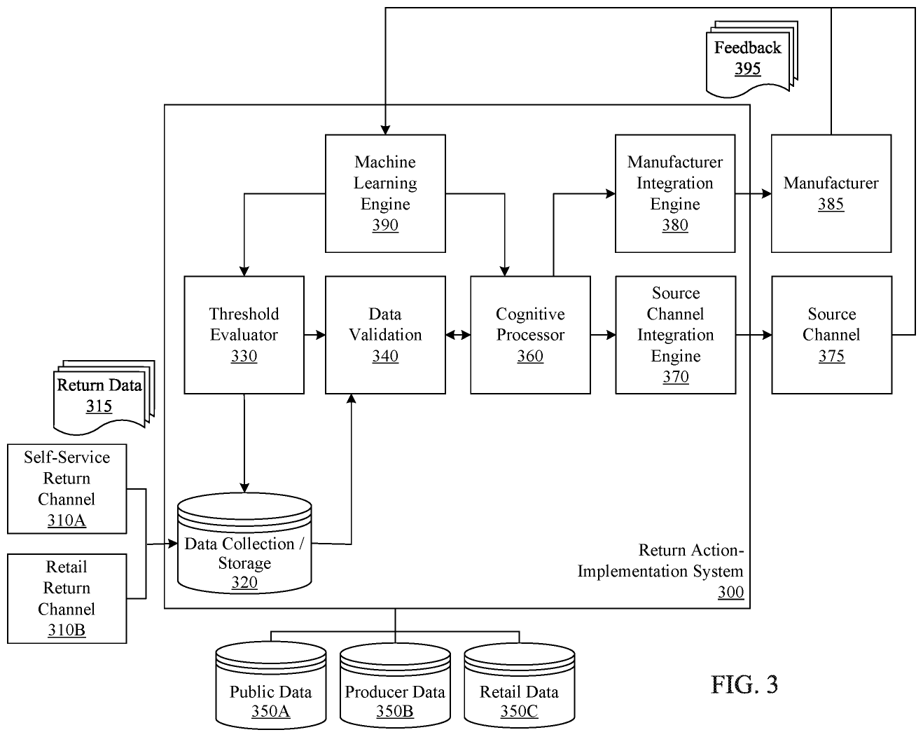

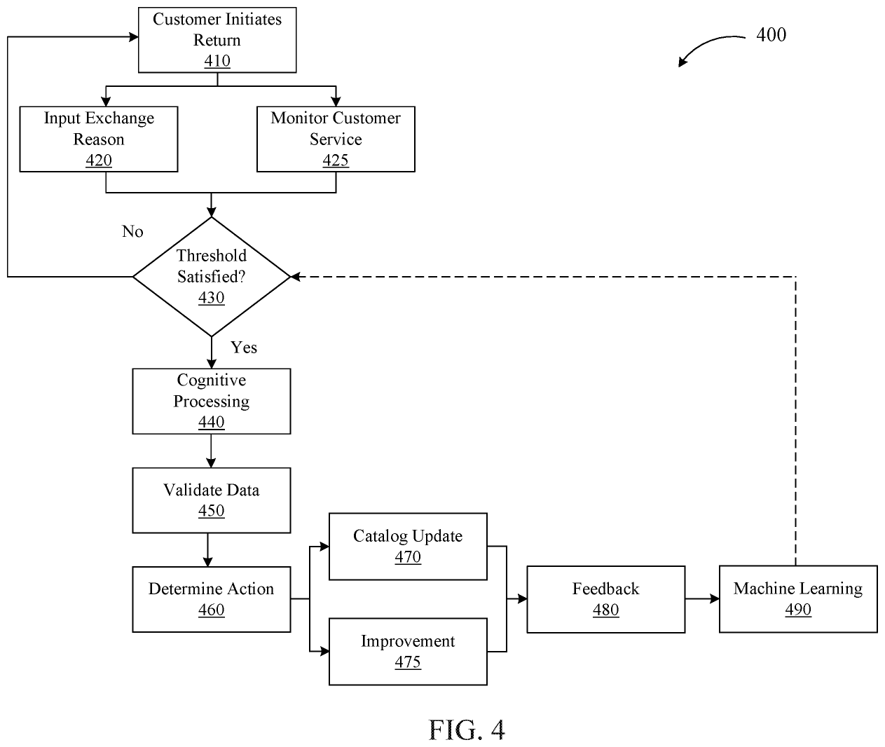

FIGS. 3 and 4 respectively illustrate an architecture 300 and methodology 400 for training and implementing a neural network-based, return action-implementation system. In 410, a user initiates a return of a product. In certain aspects, the return of the product involves the reasoning of a ‘found better item.’ This can exclude exchanging the originally-obtained product for a different product from the same supplier or by returning the originally-obtained product to the original supplier and obtaining the different product from different suppliers. The channel by which the product is returned is not limited. For example, in certain aspects, as in 420, the user can use a self-service return channel 310A. In other aspects, as in 425, the user can use a retail return channel 310B. In both instances, the user can supply return information associated with the return.

As used herein, the term “return information” or “return data” is information collected by the return channels 310A, 310B and can include, for example, the name of the item, a specific identifier associated with the item (e.g., a UPC code or manufacturer identification number), a location of where the item was purchased and/or a location of the purchaser, an item category, an item classification. Return information 315, in the instance in which a ‘found better item’ reasoning is provided can also include information about the better item including specific identifiers associated with the item as well as distinguishing attributes/features about the item such as those attributes/features that caused the user to switch from the originally-obtained product to the different product. Return data 315 includes both pre- and post-processed return data 315. In certain aspects, only return data 315 associated with ‘found better item’ is forwarded to the return action-implement system 300.

An example, in 420, the self-service return channel 310 can include a web portal through which the user can identify the originally-obtained product to be returned as well as the different product in place of the product to be returned. Via the web portal, the self-service return channel 310 can be configured to request additional information about why originally-obtained product was returned. Similar return information 315 can be obtained by a customer service representative (CSR) located at a physical store, at a call center, or online in 425. This return data 315 can then be electronically captured and forwarded to the return action-implementation system 300.

The return data 315 from the return channels 310A-B is received, processed, and stored by data collection/storage 320. For example, an audio recording of an interaction between a CSR and a user can be provided and the data collection/storage 320 can apply speech-to-text conversion techniques on the audio recording to obtain a transcript (i.e., textual representation) of the interaction. Natural language processing can then by applied on the textual representation to derive relevant return data 315. The natural language processing can also be applied to textual data received from either return channel 310A-B. While described as being part of the return action-implementation system 300, the speech-to-text conversion techniques and the natural language processing can also be applied by the return channels 310A-B themselves. Once the return data 315 has been obtained, this return data 315 will be stored for subsequent evaluation by the return action-implementation system 300.

In 430, the threshold evaluator 330 of the return action-implementation system 300 evaluates the return data 315 based upon one or more thresholds. These thresholds can include but are not limited to one or more of: item category (e.g., apparel, toys, furniture), item classification (e.g., heavy, hazardous), and item identification. The thresholds can also be associated with a period (e.g., a period of time to which the threshold applies), a specific market/location (e.g., orders fulfilled in California are evaluated with a different threshold than orders fulfilled in Massachusetts), and the particular selling channel (e.g., online versus a physical location). If the threshold is not satisfied the process 400 returns to gathering return data 315 (i.e., operations 410-425).

Once the one or more thresholds have been satisfied, in 440 and 450, the return data 315 is cognitive processed by a cognitive processor 360 and validated by a data validation unit 340. Although shown being performed in series, operations 440, 450 can be performed in parallel and/or in a different order. The data validation operations in 450 can include validating the return data 315 against multiple sources including publicly-available data 350A, producer/manufacturer data 350B, and retail data 350C. The publically-available data 350A can include, for example, data available from the internet such as product reviews, consumer complain forums, and relevant social media posts. The producer/manufacturer data 350B can include product specifications and installation/user manuals. The retail data 350A can include catalog data and/or promotional materials that provide attributes/features about the product. The purpose of the data validation operations can include both confirming that the return data 315 accurately reflects the difference between the originally-obtained product and the new product as well as supplementing the return data 315 with additional attributes/features that distinguish the originally-obtained product from the new product. As another example, the return data 315 can be used with the producer/manufacturer data 350B to confirm that the product was properly installed and/or used.

In 440, cognitive processing is performed on the return data 315 using a neural-network powered cognitive processor 360 to generate insights into the return based on comparing attributes/features of the originally-obtained product to attributes/features of the new product. As used herein, an “insight” identifies one or more attributes/features that caused a user to exchange the originally-obtained product for the new product. For example, a determination may be made that a customer exchanged Product A for Product B because Product B offers better memory while at a similar price.

In 460, a real-time corrective action is determined using one of a source channel integration engine(s) 370 or a manufacturer integration engine 380 based upon the insight identified by the cognitive processor 360. Although shown separate from the cognitive processor 360, one or both components can be integral with the cognitive processor 360. A corrective action to the manufacturer 385 by the manufacturer integration engine 380 can include, for example, a directive to manufacture a product with an improved feature list. A corrective action by the source channel integration engine 370 can include rearranging presentation of features for the originally-obtained product to highlight positive characteristics of the originally-obtained product. Another corrective action could be to display the new product in close proximity to the originally-obtained product to ensure that a user can easily compare the two.

In 470, the return action-implementation system 300 is configured to communicate the corrective action to one of the manufacturers/producers 385 or a source channel 375 using electronic messaging. The source channel 375 can include, for example, a retailer of the product. Although limited in this manner, the system 300 can communicate to the source channel 375 using a Product Information Management (PIM) API.

In 480, feedback 395 associated with the corrective action is generated and forwarded to the machine learning engine 390 (i.e., neural network). The return action-implementation system 300 is not limited in how the feedback 395 is generated or the contents of the feedback 395. However, the feedback 395 does relate to the effectiveness of the corrective action communicated to either the manufacturer 385 or the source channel 375. For example, the source channel 375 or the manufacturer 385 could provide data indicating that the corrective action was implemented. Alternatively, the return action-implementation system 300 could actively monitor the source channel 375 or the manufacturer 385 and decide that the corrective action was not implemented within a predetermined period of time.

In 490, the neural network 390 is trained using the feedback 395. There are many different types of techniques that can be used to train a neural network 390 and the return action-implementation system 300 is not limited as to a particular approach. However, in certain aspects, the system 300 employs the training techniques described in reference to FIGS. 1 and 2. Based upon the feedback 395, the neural network 390 can, for example, adjust the threshold utilized by the threshold evaluator 330. For example, if a source channel approves a corrective action based upon a particular threshold being satisfied, this particular threshold can be rewarded. Alternatively, if a source channel rejects a corrective action based upon a particular threshold being satisfied, this particular threshold will be associated with a negative reward, which could cause the threshold to be increased (and thereby less likely to be satisfied).

The neural network 390 can also be trained, using the feedback 395, to change the particular corrective action being generated. For example, corrective actions associated with positive feedback can be rewarded, and corrective actions associated with negative feedback will receive negative feedback.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

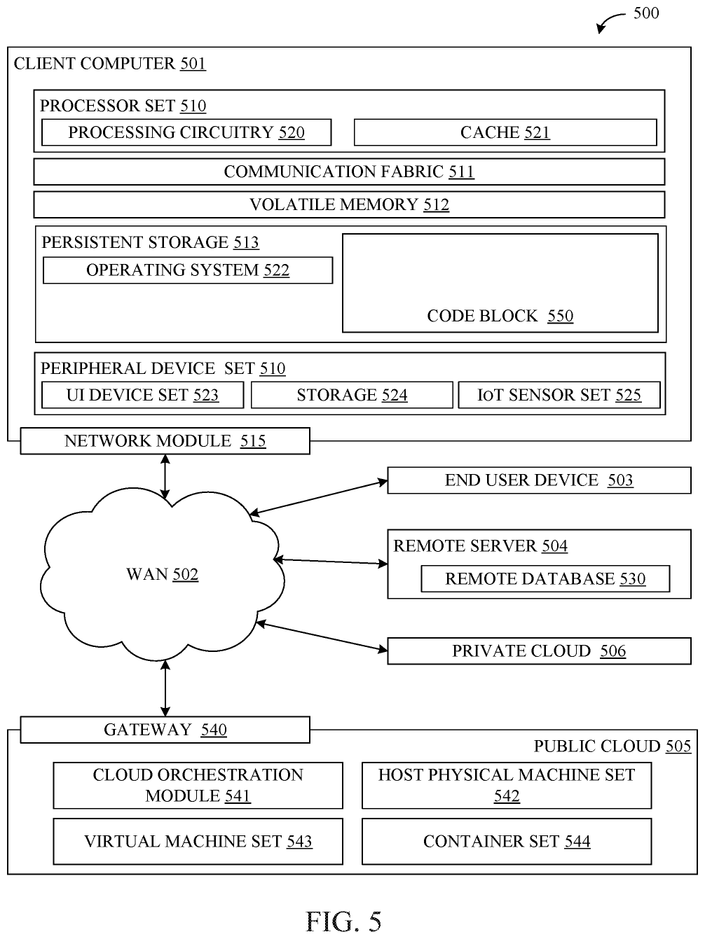

Referring to FIG. 5, computing environment 500 contains an example of an environment for the execution of at least some of the computer code involved in performing the inventive methods, such as code block 550 for implementing the operations of return action-implementation system 300 of FIG. 3. Computing environment 500 includes, for example, computer 501, wide area network (WAN) 502, end user device (EUD) 503, remote server 504, public cloud 505, and private cloud 506. In certain aspects, computer 501 includes processor set 510 (including processing circuitry 520 and cache 521), communication fabric 511, volatile memory 512, persistent storage 513 (including operating system 522 and method code block 550), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 530. As is well understood in the art of computer technology, and depending upon the technology, performance of a computer-implemented method may be distributed among multiple computers and/or between multiple locations. However, to simplify this presentation of computing environment 500, detailed discussion is focused on a single computer, specifically computer 501. Computer 501 may or may not be located in a cloud, even though it is not shown in a cloud in FIG. 5 except to any extent as may be affirmatively indicated.

Processor set 510 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In certain computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in code block 550 in persistent storage 513.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Communication fabric 511 is the signal conduction paths that allow the various components of computer 501 to communicate with each other. Typically, this communication fabric 511 is made of switches and electrically conductive paths, such as the switches and electrically conductive paths that make up busses, bridges, physical input/output ports and the like. Other types of signal communication paths may be used for the communication fabric 511, such as fiber optic communication paths and/or wireless communication paths.

Volatile memory 512 is any type of volatile memory now known or to be developed in the future. Examples include dynamic type random access memory (RAM) or static type RAM. Typically, the volatile memory 512 is characterized by random access, but this is not required unless affirmatively indicated. In computer 501, the volatile memory 512 is located in a single package and is internal to computer 501. In addition to alternatively, the volatile memory 512 may be distributed over multiple packages and/or located externally with respect to computer 501.

Persistent storage 513 is any form of non-volatile storage for computers that is now known or to be developed in the future. The non-volatility of the persistent storage 513 means that the stored data is maintained regardless of whether power is being supplied to computer 501 and/or directly to persistent storage 513. Persistent storage 513 may be a read only memory (ROM), but typically at least a portion of the persistent storage 513 allows writing of data, deletion of data and re-writing of data. Some familiar forms of persistent storage 513 include magnetic disks and solid-state storage devices. Operating system 522 may take several forms, such as various known proprietary operating systems or open-source Portable Operating System Interface type operating systems that employ a kernel. The code included in code block 550 typically includes at least some of the computer code involved in performing the inventive methods.

Peripheral device set 514 includes the set of peripheral devices for computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some aspects, storage 524 may take the form of a quantum computing storage device for storing data in the form of qubits. In aspects where computer 501 is required to have a large amount of storage (for example, where computer 501 locally stores and manages a large database) then this storage 524 may be provided by peripheral storage devices designed for storing very large amounts of data, such as a storage area network (SAN) that is shared by multiple, geographically distributed computers. Internet-of-Things (IoT) sensor set 525 is made up of sensors that can be used in IoT applications. For example, one sensor may be a thermometer and another sensor may be a motion detector.

Network module 515 is the collection of computer software, hardware, and firmware that allows computer 501 to communicate with other computers through a Wide Area Network (WAN) 502. Network module 515 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 515 are performed on the same physical hardware device. In other aspects (for example, aspects that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any Wide Area Network (for example, the internet) capable of communicating computer data over non-local distances by any technology for communicating computer data, now known or to be developed in the future. In some aspects, the WAN 502 may be replaced and/or supplemented by local area networks (LANs) designed to communicate data between devices located in a local area, such as a Wi-Fi network. The WAN 502 and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501) and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In certain aspects, EUD 503 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television, and the like. Network infrastructure, such as routers, firewalls, switches, access points and the like, are not client devices as the term “client device” is defined herein. As defined herein, the term “user” means a person (i.e., a human being).

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504. As defined herein, the term “server” means a data processing system configured to share services with one or more other data processing systems.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other aspects, a private cloud 506 may be disconnected from the internet entirely (e.g., WAN 502) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 505 and private cloud 506 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method for training a neural network, comprising:
evaluating return data, received from a return channel, against a threshold;
validating, based upon the threshold being satisfied, the return data;
cognitive processing, based upon the threshold being satisfied, the return data to generate a return insight;
generating, using the neural network and based upon the return insight, a corrective action;
training the neural network using feedback generated based upon the corrective action; and
updating, using the neural network, the threshold.

2. The method of claim 1, wherein
the return data include attribute data of an originally-obtained product and feature data of a new product.

3. The method of claim 2, wherein
the cognitive processing includes comparing the attribute data on the originally-obtained product with the attribute data of the new product.

4. The method of claim 1, wherein
the validating the return data includes supplementing the return data with additional attribute data.

5. The method of claim 1, wherein
generating the corrective action includes:
generating an electronic message, and
electronically communicating the electronic message to the manufacturer, and
the electronic message identifies the corrective action.

6. The method of claim 5, wherein
the feedback is generated based upon monitoring the manufacturer for implementation of the corrective action.

7. The method of claim 1, wherein
generating the corrective action includes:
generating an electronic message, and
electronically communicating the electronic message to the supplier, and
the electronic message identifies the corrective action.

8. The method of claim 7, wherein
the corrective action includes readjusting an electronic display of a product attribute of an originally-obtained product.

9. A computer hardware system for training a neural network, comprising:
a hardware processor configured to perform the following executable operations:
evaluating return data, received from a return channel, against a threshold;
validating, based upon the threshold being satisfied, the return data;
cognitive processing, based upon the threshold being satisfied, the return data to generate a return insight;
generating, using the neural network and based upon the return insight, a corrective action;
training the neural network using feedback generated based upon the corrective action; and
updating, using the neural network, the threshold.

10. The system of claim 9, wherein
the return data include attribute data of an originally-obtained product and feature data of a new product.

11. The system of claim 10, wherein
the cognitive processing includes comparing the attribute data on the originally-obtained product with the attribute data of the new product.

12. The system of claim 9, wherein
the validating the return data includes supplementing the return data with additional attribute data.

13. The system of claim 9, wherein
generating the corrective action includes:
generating an electronic message, and
electronically communicating the electronic message to the manufacturer, and
the electronic message identifies the corrective action.

14. The system of claim 13, wherein
the feedback is generated based upon monitoring the manufacturer for implementation of the corrective action.

15. The system of claim 9, wherein
generating the corrective action includes:
generating an electronic message, and
electronically communicating the electronic message to the supplier, and
the electronic message identifies the corrective action.

16. The system of claim 15, wherein
the corrective action includes readjusting an electronic display of a product attribute of an originally-obtained product.

17. A computer program product, comprising:
a computer readable storage medium having stored therein program code for training a training dataset,
the program code, which when executed by a computer hardware system, cause the computer hardware system to perform:
evaluating return data, received from a return channel, against a threshold;
validating, based upon the threshold being satisfied, the return data;
cognitive processing, based upon the threshold being satisfied, the return data to generate a return insight;
generating, using the neural network and based upon the return insight, a corrective action;
training the neural network using feedback generated based upon the corrective action; and
updating, using the neural network, the threshold.

18. The computer program product of claim 17, wherein
the return data include attribute data of an originally-obtained product and feature data of a new product,
the cognitive processing includes comparing the attribute data on the originally-obtained product with the attribute data of the new product, and
the validating the return data includes supplementing the return data with additional attribute data.

19. The computer program product of claim 17, wherein
generating the corrective action includes:
generating an electronic message, and
electronically communicating the electronic message to the manufacturer,
the electronic message identifies the corrective action, and
the feedback is generated based upon monitoring the manufacturer for implementation of the corrective action.

20. The computer program product of claim 17, wherein
generating the corrective action includes:
generating an electronic message, and
electronically communicating the electronic message to the supplier,
the electronic message identifies the corrective action, and
the corrective action includes readjusting an electronic display of a product attribute of an originally-obtained product.
